(19) United States
(12) Patent Application Publication
(10) Pub. No.: US 2023/0376574 A1
(43) Pub. Date: Nov. 23, 2023

(54) INFORMATION PROCESSING DEVICE AND METHOD, AND INFORMATION PROCESSING SYSTEM

(71) Applicant: SONY GROUP CORPORATION, TOKYO (JP)

(72) Inventor: TATSUYA IGARASHI, TOKYO (JP)

(21) Appl. No.: 18/248,387

(22) PCT Filed: Oct. 5, 2021
(86) PCT No.: PCT/JP2021/036731

§ 371 Date: Apr. 10, 2023

(30) Foreign Application Priority Data
Oct. 19, 2020 (JP) 2020-175444

(51) Int. Cl. G06F 21/10; H04L 9/14; H04L 9/08; G06N 5/04

(52) U.S. Cl. CPC G06F 21/1074; H04L 9/14; H04L 9/0819; G06N 5/04

(57) ABSTRACT

The present technology relates to an information processing device and method, and an information processing system capable of enabling appropriate protection of rights. An information processing device includes: a communication unit that receives from a license provider a license including a first key and a second key, the first key being for decrypting an encrypted inference model, the second key being for encrypting an inference result obtained by inference in response to input data to the inference model or for encrypting the input data; a decryption unit that decrypts the encrypted inference model based on the first key included in the license; and an inference engine that performs the inference based on the inference model. The present technology can be applied to an information processing system.

### TECHNICAL FIELD

The present technology relates to an information processing device and method, and an information processing system, and in particular, to an information processing device and method, and an information processing system capable of enabling appropriate protection of rights.

### BACKGROUND ART

Conventionally, copyright protection (digital rights management, DRM) technology that restricts playback of audio/visual (A/V) content such as movies has been available for more than 20 years.

In such technology, content to be protected is encrypted by an A/V content provider, and a license including a key for decrypting the content is distributed.

As a result, only licensed A/V content playback devices can decrypt and play back content to be protected, enabling content copyright management.

Incidentally, in recent years, an inference model obtained by machine learning is known. In the inference model, for example, predetermined inference is performed by arithmetic processing based on input data, and an inference result is output accordingly.

Applying a general DRM mechanism to such an inference model will make it possible to protect the rights of the inference model.

However, a license for decrypting the inference model cannot manage the encryption of the inference result output by the inference engine (inference model). In other words, it is not possible to protect the rights of the inference result.

For example, it is conceivable that the inference engine encrypts the inference result with a key generated independently. However, in such an approach, the license server cannot manage the decryption of the inference result in accordance with a licensing rule for the inference result, defined by the inference model provider.

On the other hand, a method is also conceivable in which a license server provides a key for encrypting an inference result to an inference engine (see PTL 1, for example).

For example, in PTL 1, a license issuing server different from the server that manages the license for the inference model distributes the issued license including the encryption key for encrypting the inference result to an image processing device, and the image processing device (inference engine) encrypts the inference result with that encryption key.

Further, an image output device, which receives the encrypted inference result supplied from the image processing device, acquires a use license including the encryption key for the inference result from the license issuing server, and uses the inference result according to the use license.

### CITATION LIST

### Patent Literature

### [PTL 1]

JP 2007-174395A

### SUMMARY

### Technical Problem

However, with the above-described technology, it is difficult to appropriately protect rights for both the inference model and the inference result.

For example, it is conceivable to simply combine the general DRM mechanism described above and the technology described in PTL 1 to encrypt each of the inference model and the inference result to distribute a license.

However, in such an approach, the licenses for the inference model and the inference result are independently distributed, and the licensing rule for the inference result cannot be enforced for devices licensed by the inference model provider. In addition, the authenticity of the inference result having been output using the corresponding inference model cannot be verified.

Moreover, if the inference engine does not have a communication function, or if the inference engine is deployed in an environment where communication is not possible, access to the license issuing server will not be possible, so that inference models and inference results cannot be used.

Furthermore, in a case where, for example, only the inference results output in a specific period are to be licensed in accordance with the licensing rule for the inference results, it is necessary to increase security by changing the encryption key for the inference results. In such a case, every time the encryption key is changed, the inference engine would require the license issuing server to issue a license, resulting in communication overhead.

The present technology has been made in view of such circumstances to enable appropriate protection of rights.

### Solution to Problem

An information processing system according to a first aspect of the present technology includes: a license provider that generates a license for an inference model; and a device that uses the inference model. In the information processing system, the license provider includes a license generation unit that generates the license including a first key and a second key based on licensing rule information that indicates a rule for licensing the inference model and either an inference result obtained by inference in response to input data to the inference model or the input data, the first key being for decrypting the inference model encrypted, the second key being for encrypting the inference result or the input data; and a first communication unit that transmits the license to the device, and the device includes a second communication unit that receives the license; a decryption unit that decrypts the encrypted inference model based on the first key included in the license; and an inference engine that performs the inference based on the inference model.

In the first aspect of the present technology, in an information processing system including a license provider that generates a license for an inference model; and a device that uses the inference model, and the license provider generates the license including a first key and a second key based on licensing rule information that indicates a rule for licensing the inference model and either an inference result obtained by inference in response to input data to the inference model or the input data, the first key being for decrypting the inference model encrypted, the second key being for encrypting the inference result or the input data, and transmits the license to the device. Further, the device receives the license, decrypts the encrypted inference model based on the first key included in the license, and executes the inference based on the inference model.

An information processing device according to a second aspect of the present technology is an information processing device corresponding to the device of the information processing system according to the first aspect of the present technology, and an information processing device according to a third aspect of the present technology is an information processing device corresponding to the license provider of the information processing system according to the first aspect of the present technology.

### BRIEF DESCRIPTION OF DRAWINGS

FIG. 1 is a diagram for explaining of a use case of the present technology.

FIG. 2 is a diagram illustrating a configuration example of an information processing system.

FIG. 3 is a diagram illustrating a configuration example of an IM provider, a license provider, and an IoT device.

FIG. 4 is a flowchart for explaining registration request processing and registration processing.

FIG. 5 is a flowchart for explaining inference execution processing and inference model licensing processing.

FIG. 6 illustrates examples of a licensing rule, an IM license, and an IR license.

FIG. 7 is a diagram illustrating a configuration example of a service server.

FIG. 8 is a flowchart for explaining IR data use processing and IR data licensing processing.

FIG. 9 is a diagram illustrating a configuration example of an information processing system.

FIG. 10 is a diagram illustrating a configuration example of a computer.

### DESCRIPTION OF EMBODIMENTS

Embodiments to which the present technique is applied will be described below with reference to the accompanying drawings.

### First Embodiment

### Present Technology

For example, in machine learning inference (deep learning inference), an inference model is used to derive an inference result from input data.

Inference model generation, that is, machine learning, requires inventiveness such as the optimization of the hierarchical structure of neural network using a large amount of appropriate training data prepared. Therefore, it is necessary for a provider of an inference model to securely protect not only the inference model but also an inference result derived by an inference engine using the inference model, and to manage the use of the inference result.

By implementing features F1 to F3 described below, the present technology issues licenses for an inference model and an inference result, enabling appropriate rights protection for both of them.

### (Feature F1)

A license provider generates, from an encryption key for an inference model and a licensing rule, a license including a decryption key for the inference model and a license including a decryption key for an inference result, so that both the inference model and the inference result can be decrypted based on the licensing rule to grant the licenses.

### (Feature F2)

A license for an inference model issued for each inference engine includes a key (Key1) for decrypting the inference model and a root encryption key (Key2) for encrypting an inference result. The inference engine encrypts the inference result with a derived key (Key3) of the root encryption key Key2.

### (Feature F3)

The inference engine encrypts the inference result with the derived key Key3 generated based on encryption conditions (input data, time, etc.) from the root encryption key. The license provider grants a license to decode the inference result in accordance with the licensing rule for the license of the inference model.

Hereinafter, the present technology will be described in more detail.

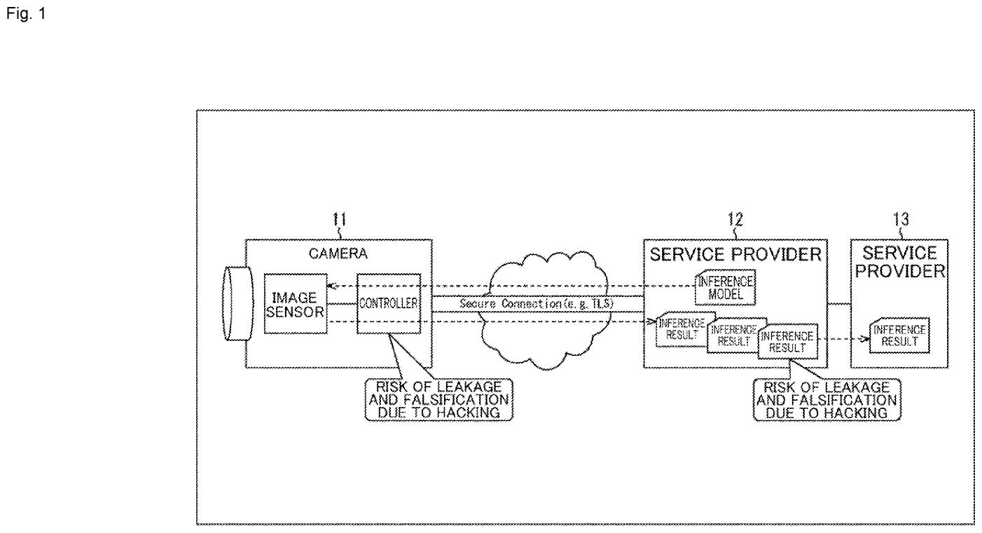

Now consider a use case in which, for example, as illustrated in FIG. 1, machine learning inference is performed using a camera 11 serving as an IoT (Internet of Things) device (Edge), and then the inference results are uploaded to a cloud made up of devices of service providers 12 and 13 and is subjected to big data analysis and the like.

In this example, the camera 11 is provided with an image sensor and a controller, and the controller acquires an inference model from the device of the service provider 12 and installs the inference model onto an inference engine installed in the image sensor.

The inference engine of the camera 11 performs inference on image data obtained by, for example, the image sensor based on the inference model, and outputs the inference results to the controller. The inference result referred to here is, for example, a result of estimating a subject included in the image data (image) input to the inference model.

The controller transmits the inference results obtained by the inference engine to the device of the service provider 12 via a network, and the device of the service provider 12 uses the inference results to perform big data analysis and the like. Further, the device of the service provider 12 supplies the inference results, the result of big data analysis, and the like to the device of the service provider 13.

In such a use case, hitherto, security protection of the communication path between the camera 11 and the device of the service provider 12, such as Transport Layer Security (TLS), prevents leakage and falsification of the inference model and inference results.

However, in this case, if a data relay point such as the controller of the camera 11 or the device of the service provider 12 is hacked, there is a risk that the inference model and inference results in the data relay point may be leaked or falsified, which is not safe.

Therefore, in the present technology, end-to-end security is achieved by encrypting data itself such as an inference model and inference results, making it possible to prevent leakage and falsification of the inference model and inference results.

Specifically, in the present technology, an encrypted inference model is supplied from the device of the service provider 12 to the controller of the camera 11. In addition, inference results supplied from the camera 11 to the device of the service provider 12 and inference results supplied from the device of the service provider 12 to the device of the service provider 13 are also encrypted.

By doing so, it is possible to protect the rights of the providers of the inference models and to prevent leakage and falsification of the inference model and the inference results.

### Configuration Example of Information Processing System

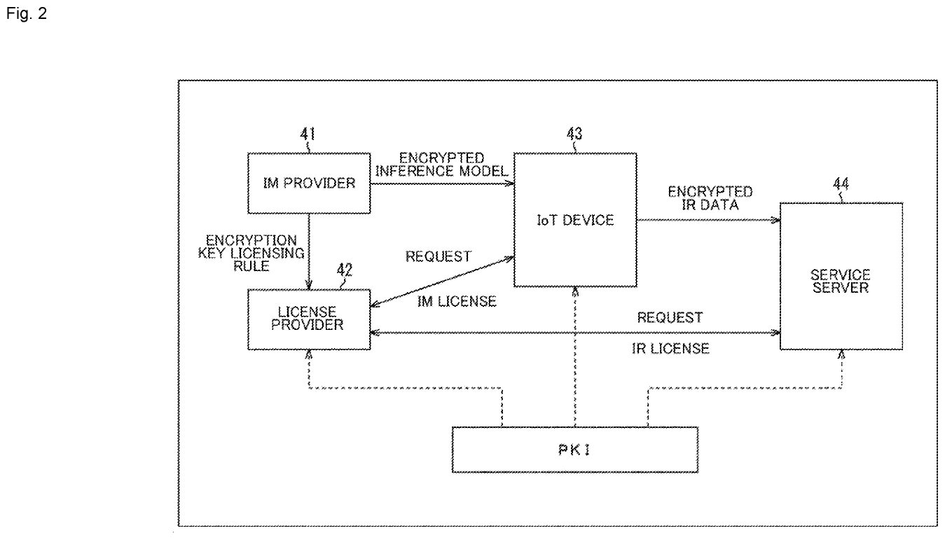

FIG. 2 is a diagram illustrating a configuration example of an embodiment of an information processing system to which the present technology is applied.

The information processing system illustrated in FIG. 2 includes an IM provider 41, a license provider 42, an IoT device 43, and a service server 44. These IM provider 41 to service server 44 are connected to each other via a network.

The IM provider 41 includes, for example, a computer managed by a provider of an inference model (IM or inferencing model).

The license provider 42 includes a server managed by a provider of a license for using an inference model provided by the IM provider 41 and a license for using an inference result (IR or inference result data) of the inference model.

Hereinafter, the license for using the inference model is also referred to as the IM license, and the license for using the inference result is also referred to as the IR license.

The IoT device 43 includes various types of devices (apparatuses) that use the inference model, such as a camera, and includes an inference engine that causes the inference model to perform inference. The inference engine generates an inference result based on the inference model and any input data.

In the following description, it is assumed that the IoT device 43 is a device having an image capture function, and image data obtained by image capture is input to the inference model as input data.

The service server 44 is, for example, a server included in a cloud for services that use inference results supplied from one or more IoT devices 43.

Although one IoT device 43 and one service server 44 are deployed in this example, a plurality of IoT devices 43 and a plurality of service servers 44 may be deployed. The service server 44 may be implemented by a plurality of devices on the network.

Therefore, for example, the IoT device(s) 43 may supply a same inference result to a plurality of service servers 44.

In a case where the inference result from the IoT device 43 may be transmitted to other service servers 44 via some service servers 44, it is difficult for communication path security such as TLS alone to satisfactorily prevent leakage or falsification of the inference result.

Furthermore, the information processing system operates a public key infrastructure (PKI) that manages public keys for public key cryptography for authentication of the IM provider 41, the license provider 42, the IoT device 43, and the service server 44. This PKI is for authentication of exchanged data such as licenses, and is different from a PKI for authentication of communication channel security such as TLS.

In the information processing system, devices and services that use inference models and inference results, that is, such as the IoT device 43 and the service server 44, are registered with the PKI in accordance with the rules for using licenses, as in the case of general DRM technology. If a rule violation is confirmed (detected), the public key is revoked in PKI.

A rough flow of processing when an IM license and an IR license is provided to a user and an inference model and an inference result is used will now be described. Note that a program such as for input/output control may be required for the inference engine to execute the inference model, and accordingly, such a control program is treated as an inference model in the following description.

First, the IM provider 41 registers with the license provider 42 an encryption key used for encrypting the inference model and a licensing rule for the inference model and the inference result.

Next, the IM provider 41 transmits an encrypted inference model that is data in which the inference model is encrypted to the IoT device 43.

In response to this, the IoT device 43 requests the license provider 42 to issue an IM license for licensing the inference model. In other words, the IoT device 43 transmits an IM license request to the license provider 42.

The license provider 42 transmits the IM license for the inference model to the IoT device 43 in response to the request from the IoT device 43. This allows the IoT device 43 to use the inference model based on the IM license.

When the IoT device 43 obtains an inference result from the inference model in response to the input data, the IoT device 43 encrypts the inference result and transmits the encrypted inference result to the service server 44. In the following, the inference result is also referred to as IR data, and the result obtained by encrypting the IR data is also referred to as encrypted IR data.

The service server 44 requests the license provider 42 to issue an IR license for licensing the inference result (IR data). In other words, the service server 44 transmits an IR license request to the license provider 42.

The license provider 42 transmits the IR license for the IR data to the service server 44 in response to the request from the service server 44. This allows the service server 44 to use the inference result (IR data) based on the IR license.

In this case, other IR data may be used depending on the conditions of use and the like stipulated in the IR license. In other words, for example, one IR license enables the use of a plurality of pieces of IR data.

### Configuration Example of IM Provider, License Provider, and IoT Device

Next, a configuration example of the IM provider 41, the license provider 42, the IoT device 43, and the service server 44, and details of processing performed by the IM provider 41 to the service server 44 will be described.

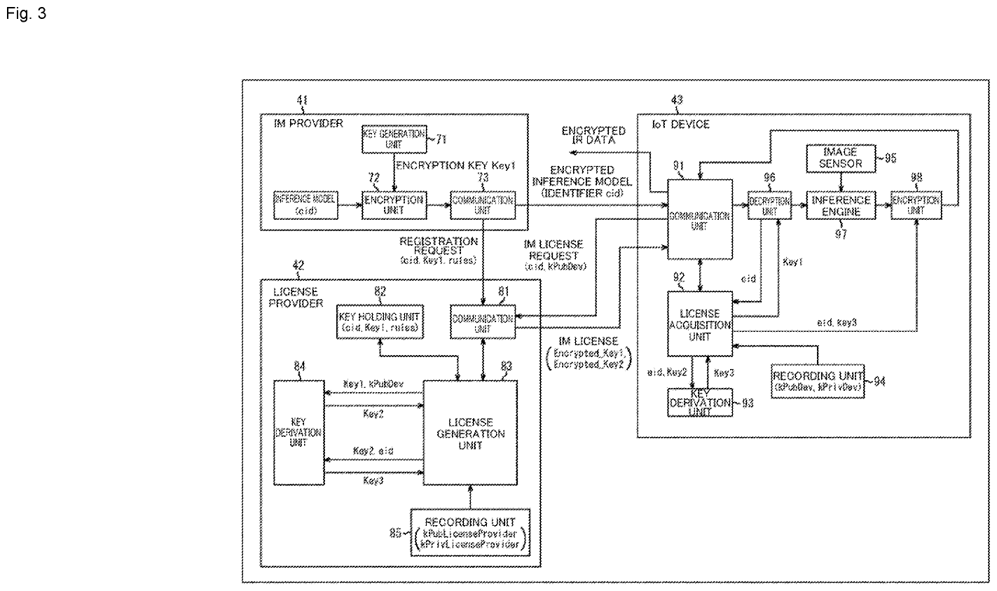

FIG. 3 is a diagram illustrating a configuration example of the IM provider 41, the license provider 42, and the IoT device 43.

The IM provider 41 includes a key generation unit 71, an encryption unit 72, and a communication unit 73.

The IM provider 41 holds an inference model in association with an identifier cid for uniquely identifying the inference model.

The key generation unit 71 generates an encryption key Key1 for common key cryptography for encrypting the inference model, and supplies the encryption key Key1 to the encryption unit 72. The encryption unit 72 encrypts the inference model with the encryption key Key1, and supplies the encrypted inference model to the communication unit 73 together with the encryption key Key1 and the identifier cid.

The encryption unit 72 sets a licensing rule Rules for the inference model and the IR data, and supplies the licensing rule Rules to the communication unit 73.

The communication unit 73 transmits to the IoT device 43 the encrypted inference model supplied from the encryption unit 72, more specifically, the IM data that is data of the inference model including the encrypted inference model and the identifier cid. The communication unit 73 also transmits to the license provider 42 a registration request to request registration of the encryption key Key1 and the licensing rule Rules, including as parameters the identifier cid, the encryption key Key1, and the licensing rule Rules, which are supplied from the encryption unit 72.

The license provider 42 includes a communication unit 81, a key holding unit 82, a license generation unit 83, a key derivation unit 84, and a recording unit 85.

The communication unit 81 communicates with the IM provider 41, the IoT device 43, and the service server 44.

For example, the communication unit 81 receives the registration request transmitted by the IM provider 41 and supplies the received registration request to the license generation unit 83.

For example, the communication unit 81 also receives the IM license request transmitted by the IoT device 43 and supplies the received IM license request to the license generation unit 83, and transmits the IM license supplied from the license generation unit 83 to the IoT device 43.

The key holding unit 82 records the identifier cid, the encryption key Key1, and the licensing rule Rules, which are supplied from the license generation unit 83, and supplies the encryption key Key1 and the licensing rule to the license generation unit 83 as necessary.

The license generation unit 83 supplies the identifier cid, the encryption key Key1, and the licensing rule Rules, which are included in the registration request supplied from the communication unit 81, to the key holding unit 82 for recording. The license generation unit 83 also issues the IM license and the IR license in accordance with the licensing rule Rules held in the key holding unit 82.

Meanwhile, for example, the license generation unit 83 instructs the key derivation unit 84 to derive an encryption key Key2 and a derived encryption key Key3 for encrypting the IR data.

The key derivation unit 84 derives the encryption key Key2 and the derived encryption key Key3 according to the instruction from the license generation unit 83, and supplies them to the license generation unit 83. The derived encryption key Key3 is used as an encryption key for common key cryptography.

The recording unit 85 records a public key kPubLicenseProvider and a private key kPrivLicenseProvider, which make a pair of keys for public key cryptography for the license provider 42. The recording unit 85 supplies the public key kPubLicenseProvider and the private key kPrivLicenseProvider to the license generation unit 83 as necessary.

The public key kPubLicenseProvider is for authentication of the license provider 42 and is managed in the PKI described above.

The IoT device 43 includes a communication unit 91, a license acquisition unit 92, a key derivation unit 93, a recording unit 94, an image sensor 95, a decryption unit 96, an inference engine 97, and an encryption unit 98.

The communication unit 91 receives the encrypted inference model from the IM provider 41, supplies the received encrypted inference model to the decryption unit 96, and supplies the IM license received from the license provider 42 to the license acquisition unit 92.

The communication unit 91 also transmits the IM license request supplied from the license acquisition unit 92 to the license provider 42, and transmits the encrypted IR data supplied from the encryption unit 98 to the service server 44.

The license acquisition unit 92 acquires the IM license from the license provider 42 via the communication unit 91.

The license acquisition unit 92 also causes the key derivation unit 93 to derive the derived encryption key Key3 for encrypting the IR data, and supplies the derived encryption key Key3 to the encryption unit 98. The key derivation unit 93 derives the derived encryption key Key3 according to the instruction of the license acquisition unit 92, and supplies the derived encryption key Key3 to the license acquisition unit 92.

The recording unit 94 records a public key kPubDev and a private key kPrivDev, which make a pair of keys for public key cryptography for the IoT device 43, and supplies the public key kPubDev and the private key kPrivDev to the license acquisition unit 92 as necessary. The public key kPubDev is for authentication of the IoT device 43 and is managed in the PKI described above.

The image sensor 95 captures an image of the surroundings of the IoT device 43 as a subject, and supplies the resulting image data to the inference engine 97 as input data.

The decryption unit 96 performs decryption processing on the encrypted inference model supplied from the communication unit 91 based on the encryption key Key1 for common key cryptography supplied from the license acquisition unit 92, and supplies the resulting inference model to the inference engine 97. The decryption unit 96 uses the encryption key Key1 as a decryption key for the encrypted inference model.

The inference engine 97 executes inference by performing arithmetic processing based on the input data supplied from the image sensor 95 and based on the inference model supplied from the decryption unit 96, and supplies the resulting IR data (inference result) to the encryption unit 98.

The encryption unit 98 encrypts the IR data supplied from the inference engine 97 based on the derived encryption key Key3 supplied from the license acquisition unit 92, and supplies the resulting encrypted IR data to the communication unit 91. Note that the encryption unit 98 may encrypt the input data with the derived encryption key Key3 that is the same as that used for encrypting the IR data or that is different from that used for encrypting the IR data.

### <Description of Registration Request Processing and Registration Processing>

Next, processing performed by the IM provider 41, the license provider 42, and the IoT device 43 will be described.

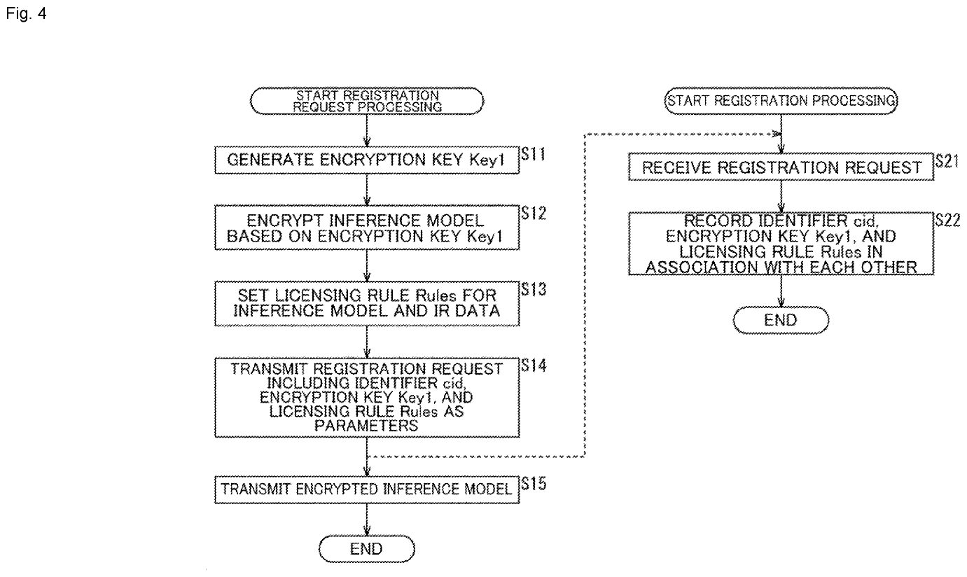

First, registration request processing performed by the IM provider 41 and registration processing performed by the license provider 42 will be described with reference to the flowchart of FIG. 4.

When the IM provider 41 starts the registration request processing, the key generation unit 71 generates an encryption key Key1 for an inference model to which an identifier cid is assigned, and supplies the encryption key Key1 to the encryption unit 72 in step S11.

For example, the key generation unit 71 generates the encryption key Key1 by generating a 32-byte random number using a pseudo-encryption generation function randam_bytes( ) as represented in the following Equation (1).

[Math. 1]

Key1=randam_bytes(32) (1)

In step S12, the encryption unit 72 encrypts the inference model based on the encryption key Key1 supplied from the key generation unit 71 to generate an encrypted inference model that is an encrypted inference model Enc_IMdata.

For example, the encryption unit 72 calculates the following Equation (2) to encrypt the inference model with the encryption key Key1 based on a common key encryption function AES.Encrypt( ) according to AES (Advanced Encryption Standard) 256. Here, IMdata in Equation (2) represents the inference model.

[Math. 2]

Eric_IMdata=AES.Encrypt(Key1,IMdata) (2)

In step S13, for the inference model, the encryption unit 72 sets (generates) a licensing rule Rules for the inference model and IR data (inference result) generated using the inference model, and supplies the licensing rule Rules to the communication unit 73.

The setting of the licensing rule Rules and the issuance of licenses based on the licensing rule Rules correspond to the feature F1 described above. The details of the licensing rule Rules will be described later.

In step S14, the communication unit 73 transmits to the license provider 42 a registration request including the identifier cid, the encryption key Key1, and the licensing rule Rules as parameters.

Specifically, the encryption unit 72 generates a registration request including the identifier cid, the encryption key Key1, and the licensing rule Rules, and supplies the registration request to the communication unit 73. The communication unit 73 transmits the registration request supplied from the encryption unit 72 to the license provider 42 via the network or the like. At this time, communication is performed using a secure communication method, such as TLS, between the IM provider 41 and the license provider 42 so that the encryption key Key1 is not leaked to a third party.

After the registration request is transmitted, processing of step S15 is performed at an arbitrary timing.

Accordingly, in step S15, the communication unit 73 acquires from the encryption unit 72 the encrypted inference model to which the identifier cid is assigned, and transmits the acquired encrypted inference model to the IoT device 43, and then the registration request processing ends.

As described above, the timing of transmitting (sending) the encrypted inference model can be any timing, such as before shipment of the IoT device 43 or in response to a request from the IoT device 43 after shipment of the IoT device 43.

In this case, the IoT device 43 acquires from the IM provider 41 an encrypted inference model that is suitable for obtaining a desired inference result for the input data, for example, an inference model that is predetermined for the data type of the input data such as image data and audio data.

When the registration request is transmitted in step S14, the license provider 42 starts the registration processing.

Accordingly, in step S21, the communication unit 81 of the license provider 42 receives the registration request transmitted from the IM provider 41 and supplies the received registration request to the license generation unit 83.

The license generation unit 83 supplies, in response to the registration request supplied from the communication unit 81, the identifier cid, the encryption key Key1, and the licensing rule Rules, which are included in the registration request, to the key holding unit 82.

In step S22, the key holding unit 82 records the identifier cid supplied from the license generation unit 83, the encryption key Key1, and the licensing rule Rules in association with each other, and then the registration processing ends. As a result, the inference model of the IM provider 41 and the licensing rule Rules are registered with the license provider 42.

As described above, the IM provider 41 generates a licensing rule Rules, which is information indicating use conditions, that is, indicating rules for licensing, for both the inference model and the inference result, and transmits a registration request to the license provider 42. The license provider 42 registers the inference model and the licensing rule Rules in response to the registration request.

In this way, for an inference model, a licensing rule Rules is generated that indicates use conditions, that is, a licensing rule Rules, for not only the inference model but also the inference result, so that the rights of both the inference model and the inference result can be protected.

### <Description of Inference Execution Processing and Inference Model Licensing Processing>

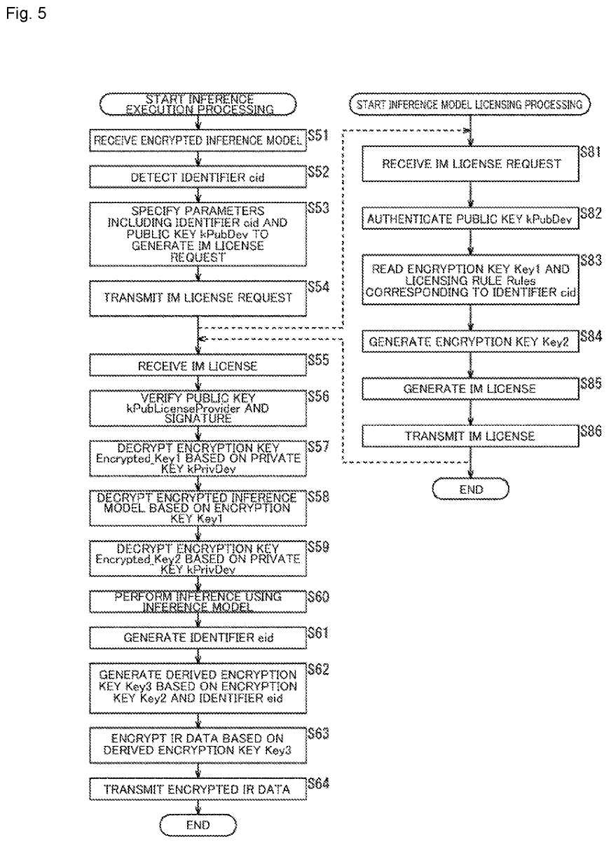

Next, inference execution processing performed by the IoT device 43 and inference model licensing processing performed by the license provider 42 will be described with reference to the flowchart of FIG. 5.

In the registration request processing described with reference to FIG. 4, the processing of step S15 is performed, and when the encrypted inference model is transmitted from the IM provider 41 to the IoT device 43, the IoT device 43 starts the inference execution processing.

Accordingly, in step S51, the communication unit 91 of the IoT device 43 receives the encrypted inference model transmitted from the IM provider 41 and supplies the received encrypted inference model to the decryption unit 96.

In step S52, the decryption unit 96 detects the identifier cid recorded in a data file of the encrypted inference model supplied from the communication unit 91, and supplies the detected identifier cid to the license acquisition unit 92.

In step S53, the license acquisition unit 92 generates an IM license request by designating parameters including the identifier cid of the inference model and the public key kPubDev for the IoT device 43, and supplies the IM license request to the communication unit 91.

In other words, the license acquisition unit 92 generates an IM license request including the identifier cid supplied from the decryption unit 96 and the public key kPubDev recorded in the recording unit 94 as parameters, and supplies the IM license request to the communication unit 91.

In step S54, the communication unit 91 transmits the IM license request supplied from the license acquisition unit 92 to the license provider 42 via the network or the like.

When the IM license request is transmitted in this way, the license provider 42 starts the inference model licensing processing.

Accordingly, in step S81, the communication unit 81 of the license provider 42 receives the IM license request transmitted from the IoT device 43 and supplies the received IM license request to the license generation unit 83.

In step S82, the license generation unit 83 authenticates the public key kPubDev for the IoT device 43 included in the IM license request supplied from the communication unit 81 in the PKI.

Here, it is assumed that the public key kPubDev has been successfully authenticated. However, if the authentication fails, the communication unit 81 transmits to the IoT device 43 an error message as a response to the IM license request according to the instruction of the license generation unit 83.

When the public key kPubDev is successfully authenticated, the license generation unit 83 reads from the key holding unit 82 the encryption key Key1 and the licensing rule Rules, which correspond to (are associated with) the identifier cid included in the IM license request, in step S83.

The license generation unit 83 supplies to the key derivation unit 84 the encryption key Key1 read from the key holding unit 82 and the public key kPubDev included in the IM license request, and instructs the key derivation unit 84 to generate (derive) an encryption key Key2.

If the key holding unit 82 does not hold the encryption key Key1 and/or the licensing rule Rules, which correspond to the identifier cid, that is, if the search for the encryption key Key1 or the like fails, the communication unit 81 transmits to the IoT device 43 an error message as a response to the IM license request according to the instruction of the license generation unit 83.

In step S84, the key derivation unit 84 generates an encryption key Key2 used to encrypt the inference result (IR data) based on the encryption key Key1 and the public key kPubDev supplied from the license generation unit 83, and supplies the encryption key Key2 to the license generation unit 83.

For example, the key derivation unit 84 calculates the following Equation (3) based on the encryption key Key1 and the public key kPubDev to derive a 32-byte encryption key using the hash function sha256 and thus to obtain an encryption key Key2 that is a derived key depending on the public key kPubDev.

[Math. 3]

Key2=hash_hdkf(‘sha256’,Key1,32,‘key1-encrypt ion’,kPubDev) (3)

Here, hash_hdkf in Equation (3) represents a derived function defined by rfc5869; ‘key1_encryption’ in Equation (3) is a salt, which may be any value.

The key derivation unit 84 generates an encryption key Key2 using an encryption key Key1 that differs for each inference model and using a public key kPubDev that differs for each IoT device 43. Therefore, a different key can be obtained as the encryption key Key2 for each inference model and for each IoT device 43 to be licensed, thereby improving security.

For example, even if the IoT device 43 is hacked for some reason and the encryption key Key2 is leaked from the IoT device 43 to the outside, the leaked encryption key Key2 cannot be used to decrypt inference results generated by other IoT devices 43 or other inference models.

Therefore, it is possible to prevent a malicious third party from using inference models used in other IoT devices 43 and inference models other than the inference model corresponding to the leaked encryption key Key2 and thus to improve security.

In addition, the same advantageous effects as the present technology can be obtained by generating a new encryption key Key2 without key derivation each time a request is made to use an inference model. However, in such a case, the key holding unit 82 is required to manage a large amount of encryption keys Key2. By contrast, in the present technology, which generates an encryption key Key2 by key derivation, the encryption key Key2 can be obtained from an encryption key Key1 and a public key kPubDev when necessary, and thus the key holding unit 82 is not required to manage a large amount of encryption keys Key2.

In step S85, the license generation unit 83 generates an IM license for the inference model identified by the identifier cid based on the encryption key Key2 supplied from the key derivation unit 84 and based on the encryption key Key1 and the licensing rule Rules that correspond to the identifier cid, which are read in step S83.

For example, the license generation unit 83 generates an IM license including: the encryption key Key1, a use rule (use conditions) for implementing the encryption key Key1 and the inference model, the encryption key Key2, and an encryption rule for generating a derived encryption key Key3 using the encryption key Key2. The generation (issuance) of such an IM license corresponds to the feature F2 described above.

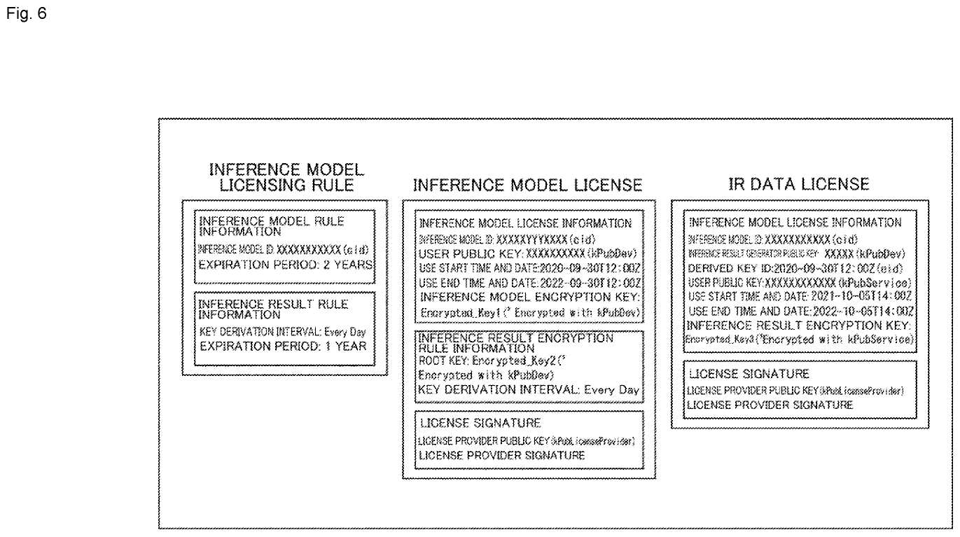

A specific example of generating an IM license will now be described with reference to FIG. 6.

On the left side of FIG. 6, an example of the licensing rule Rules for an inference model is indicated.

In this example, the licensing rule Rules includes “inference model rule information” that indicates a use rule (use conditions) for the inference model and “inference result rule information” that indicates a use rule for the inference result (IR data). Such a licensing rule Rules is registered with the key holding unit 82.

The inference model rule information includes an “inference model ID” and an “expiration period”.

The “inference model ID” is an ID (identifier) for identifying the inference model, and as used herein is an identifier cid indicating the inference model for which the IM license is to be granted.

The “expiration period” included in the inference model rule information indicates an expiration period of the IM license after the IM license is issued, that is, a period of time during which the inference model is allowed to be used. In this example, an expiration period of “2 years” is specified for the IM license.

On the other hand, the inference result rule information includes “key derivation interval” and “expiration period”.

The “key derivation interval” is information indicating a time interval for generating a derived encryption key Key3, which is a derived key for encrypting the inference result (IR data).

For example, as the “key derivation interval”, a value such as “EveryDay”, “EveryWeek”, “EveryMonth”, or “EveryYear” is specified. Especially in this example, “EveryDay” is specified as the “key derivation interval”. Alternatively, the “key derivation interval” may be generated for each inference result.

The derived encryption key Key3 is generated periodically at the time interval indicated by the “key derivation interval” included in the inference result rule information, starting from the time and date of the start of use of the IM license. The same derived encryption key Key3 (encryption key Key2) is used to encrypt the inference result during that interval.

The use of the encryption key Key2, that is, the mechanism of key derivation, allows the license provider 42 to collectively license the use of a plurality of inference results generated within a specific period.

The “key derivation interval” included in the inference result rule information corresponds to the feature F3 described above. In this example, the time indicated by the “key derivation interval”, that is, the period of time available for the derived encryption key Key3, is a condition for encrypting the inference result.

In other words, an encryption condition is to generate a derived encryption key Key3 for each specified period. However, the encryption condition is not limited to time such as “key derivation interval”, and may be any condition such as generating a derived encryption key Key3 for each inference result.

The “expiration period” included in the inference result rule information indicates an expiration period of an IR license for the inference result (IR data) after the IR license is issued, that is, a period of time during which the inference result is allowed to be used. In this example, an expiration period of “1 year” is specified for the IR license.

Especially in this example, it is possible to specify an expiration period for the IM license and an expiration period for the IR license separately.

The license generation unit 83 reads the encryption key Key1 corresponding to the identifier cid and the licensing rule Rules indicated on the left side of FIG. 6 from the key holding unit 82, and generates an IM license for the inference model indicated in the middle of FIG. 6 and an IR license for the IR data indicated on the right side of FIG. 6.

The IM license for the inference model indicated in the middle of FIG. 6 includes three pieces of information: “inference model license information”, “inference result encryption rule information”, and “license signature”.

The inference model license information for the IM license includes (describes) “inference model ID”, “user public key”, “use start time and date”, “use end time and date”, and “inference model encryption key”.

For example, the “inference model ID” included in the inference model license information indicates the inference model ID of the inference model for which the IM license is to be granted, that is, the identifier cid.

The license generation unit 83 specifies (stores), as the “inference model ID” included in the inference model license information, the same value as the identifier cid specified as a parameter in the IM license request and described in the data of the inference model and the licensing rule Rules.

The “user public key” indicates the public key for the user of the inference model, that is, the IoT device 43. The license generation unit 83 stores, as the “user public key”, the public key kPubDev for the IoT device 43 specified as a parameter in the IM license request into the inference model license information. As a result, it is possible to identify which IoT device 43 the IM license is issued to.

The “use start time and date” indicates the start time and date of use of the IM license. Normally, the license generation unit 83 stores, as the “use start time and date”, the time and date when the IM license was issued into the inference model license information.

The “use end time and date” indicates the end time and date of use of the IM license. The license generation unit 83 calculates the use end time and date from the use start time and date of the IM license and the “expiration period” described in the inference model rule information in the licensing rule Rules, and stores the calculated use end time and date as the “use end time and date” into the inference model license information.

The “inference model encryption key” indicates a value (Encrypted_Key1) obtained by encrypting the encryption key Key1, which is the key for decrypting the inference model, by public key cryptography, that is, the encrypted encryption key Key1.

In this example, the license generation unit 83 encrypts the encryption key Key1 by using, as the encryption key for public key cryptography, the public key kPubDev for the IoT device 43, which corresponds to the user specified as a parameter in the IM license request.

Specifically, for example, in a case where the Rivest Shamir Adleman (RSA) encryption specified in Rfc 8017 is used, the license generation unit 83 calculates the following Equation (4) based on the public key kPubDev and the encryption key Key1 to encrypt the encryption key Key1.

[Math. 4]

Encrypted_Key1=RSAES−OAER encrypt(kPubDev,Key1) (4)

Here, Encrypted_Key1 in Equation (4) represents the encrypted encryption key Key1. The license generation unit 83 stores the encrypted encryption key Key1 as the “inference model encryption key” into the inference model license information.

In this way, by encrypting the encryption key Key1 with the public key kPubDev for the IoT device 43, which corresponds to the user, only the user to which the IM license is granted, that is, the IoT device 43 can decrypt the inference model by using the encryption key Key1 to use the inference model.

A “root key” and a “key derivation interval” are included (described) in the inference result encryption rule information for the IM license.

This inference result encryption rule information is generated based on the inference result rule information and others in the licensing rule Rules.

The “root key” indicates a root key used for encrypting the inference result, that is, a value (Encrypted_Key2) obtained by encrypting the encryption key Key2 by public key cryptography.

In this example, as with the encrypted encryption key Key1 (Encrypted_Key1), the license generation unit 83 encrypts the encryption key Key2 with the public key kPubDev for the IoT device 43, which corresponds to the user, specified as a parameter in the IM license request. Specifically, for example, the same calculation as in Equation (4) is performed to generate the encrypted encryption key Key2 (Encrypted_Key2).

The “key derivation interval” included in the inference result encryption rule information is information indicating a time interval for generating a derived encryption key Key3, which is the derived key used to encrypt the inference result.

The license generation unit 83 stores (specifies) the same value as the “key derivation interval” in the licensing rule Rules as the “key derivation interval” in the inference result encryption rule information. Therefore, in this example, “EveryDay” is specified as the “key derivation interval”.

The inference result encryption rule information indicates encryption conditions such as what type of key is used and how encryption is performed, that is, under what condition (rule) encryption is performed.

For example, in this example, the inference result encryption rule information indicates encryption conditions that the inference result is to be encrypted with the derived encryption key Key3 generated every day based on the encryption key Key2.

As described above, the encryption conditions may be, for example, encryption conditions that the inference result is to be encrypted with the derived encryption key Key3 generated for each inference result based on the encryption key Key2.

By the inference result encryption rule information including the “root key”, that is, the encrypted encryption key Key2, the feature F2 described above can be implemented; by the inference result encryption rule information including the “key derivation interval”, the feature F3 described above can be implemented.

For example, DRM licenses for typical A/V content do not include information to encrypt another content (inference result) generated from such A/V content (inference model), so that it is difficult to properly protect the rights of both the inference model and the inference result.

The “license signature” for the IM license includes (describes) a “license provider public key” and a “license provider signature”.

The “license provider public key” indicates the public key kPubLicenseProvider for the license provider 42 that issues the IM license.

The “license provider signature” indicates a public key cryptographic signature (Sign) for verifying and authenticating the authenticity of the “inference model license information” and the “inference result encryption rule information” for the IM license.

The license generation unit 83 stores the public key kPubLicenseProvider paired with the private key kPrivLicenseProvider for the license provider 42 used for generating the public key cryptographic signature Sign as the “license provider public key” into the IM license.

The license generation unit 83 generates the public key cryptographic signature (Sign) based on the private key kPrivLicenseProvider for the license provider 42 that is the issuer of the IM license and based on the inference model license information and the inference result encryption rule information, and uses the public key cryptographic signature (Sign) as the “license provider signature”.

Specifically, for example, the license generation unit 83 sets as Message (a message) a value obtained by concatenating all the parameters described in the “inference model license information” and the “inference result encryption rule information” included in the IM license.

Then, the license generation unit 83 calculates the following Equation (5) based on Message to obtain a hash value LicenseHash. This hash value LicenseHash is a hash value of some information included in the IM license.

[Math. 5]

LicenseHash=sha256(Message) (5)

Next, the license generation unit 83 calculates the following Equation (6) to sign the hash value LicenseHash with the private key kPrivLicenseProvider to obtain the public key encryption signature Sign.

[Math. 6]

Sign=ECDSA.sign(kPrivLicenseProvider,LicenseHash) (6)

By performing the above processing, the license generation unit 83 generates the IM license.

Although the details will be described later, the IR license for the inference result (IR data) is indicated on the right side of FIG. 6.

The IR license includes “inference result license information” and a “license signature”.

The “inference result license information” includes (describes) an “inference model ID”, an “inference result generator public key”, a “derived key ID”, a “user public key”, “use start time and date”, “use end time and date”, and an “inference result encryption key”.

The “inference model ID” indicates the inference model ID of the inference model for which the IR license is to be granted, that is, the identifier cid. The “inference result generator public key” indicates the public key kPubDev for the IoT device 43 that has generated the inference result (IR data) using the inference model.

The “derived key ID” indicates an ID (identifier) for identifying the derived encryption key Key3 used to encrypt the inference result. The “user public key” indicates the public key for the service server 44 that is the user of the inference result.

The “use start time and date” and the “use end time and date” in the inference result license information indicate the use start time and date and the use end time and date of the IR license. Normally, the “use start time and date” is the time and date when the IR license was issued.

The “inference result encryption key” indicates a value (Encrypted_Key3) obtained by encrypting the derived encryption key Key3 for decrypting the inference model, by public key cryptography, that is, the encrypted encryption key Key3.

The “license signature” for the IR license includes (describes) the “license provider public key” and the “license provider signature”.

The “license provider public key” indicates the public key kPubLicenseProvider for the license provider 42 that issues the IR license.

The “license provider signature” indicates a public key cryptographic signature for verifying and authenticating the authenticity of the “inference result license information” for the IR license.

Returning to the description of the flowchart of FIG. 5, in step S85, the license generation unit 83 generates the IM license including the encrypted encryption key Key1 and the encrypted encryption key Key2, and supplies the IM license to the communication unit 81.

In step S86, the communication unit 81 transmits the IM license supplied from the license generation unit 83 to the IoT device 43 via the network or the like, and then the inference model licensing processing ends.

When the processing of step S86 has been performed, the IoT device 43 performs processing of step S55.

Accordingly, in step S55, the communication unit 91 receives the IM license transmitted from the license provider 42 and supplies the received IM license to the license acquisition unit 92.

In step S56, the license acquisition unit 92 verifies the public key kPubLicenseProvider and the public key encryption signature Sign.

Specifically, first, the license acquisition unit 92 authenticates (verifies) the public key kPubLicenseProvider for the license provider 42 included in the IM license supplied from the communication unit 91 in the PM.

After that, the license acquisition unit 92 verifies the public key encryption signature Sign included in the IM license.

Specifically, for example, the license acquisition unit 92 sets as Message (a message) a value obtained by concatenating all the parameters described in the “inference model license information” and the “inference result encryption rule information” included in the IM license indicated in FIG. 6.

Next, the license acquisition unit 92 calculates the following Equation (7) based on Message to obtain a hash value LicenseHash.

[Math. 7]

LicenseHash=sha256(Message) (7)

The license acquisition unit 92 also calculates the following Equation (8) based on the hash value LicenseHash, the public key cryptographic signature Sign, and the public key kPubLicenseProvider to verify the public key cryptographic signature Sign. Here, the public key encryption signature Sign and the public key kPubLicenseProvider are included in the IM license.

[Math. 8]

Result=ECDSA.verify(Sign,LicenseHash,kPubLicenseProvider) (8)

In step S57, the license acquisition unit 92 decrypts the encrypted encryption key Key1 included in the IM license, that is, the encryption key Encrypted_Key1, based on the private key kPrivDev.

For example, the license acquisition unit 92 confirms that the user public key included in the inference model license information for the IM license indicated in FIG. 6 coincides with the public key kPubDev for the IoT device 43 itself recorded in the recording unit 94. The license acquisition unit 92 also reads the private key kPrivDev for the IoT device 43 from the recording unit 94.

The license acquisition unit 92 calculates the following Equation (9) based on the private key kPrivDev to decrypt the encryption key Encrypted_Key1 included in the IM license, that is, the encrypted encryption key Key1, and thus obtain the encryption key Key1. Equation (9) performs decryption for the RSA public key encryption.

[Math. 9]

Key1=RSAES-OAEP.decrypt(kPrivDev,Encrypted_Key1) (9)

The license acquisition unit 92 supplies the encryption key Key1 obtained by the decryption to the decryption unit 96.

In step S58, the decryption unit 96 decrypts, based on the encryption key Key1 supplied from the license acquisition unit 92, the encrypted inference model received in step S51 and supplied from the communication unit 91, that is, the encrypted inference model, and supplies the resulting inference model to the inference engine 97.

For example, the decryption unit 96 calculates the following Equation (10) based on the encryption key Key1 and the encrypted inference model to obtain the inference model. Here, encrypted_IM in Equation (10) represents the encrypted inference model, and Equation (10) performs decryption for the AES common key encryption.

[Math. 10]

IM=AES.decrypt(Key1,encrypted_IM) (10)

In step S59, the license acquisition unit 92 calculates the following Equation (11) based on the private key kPrivDev to decrypt the encryption key Encrypted_Key2 included in the “inference result encryption rule information” for the IM license in FIG. 6, that is, the encrypted encryption key Key2.

[Math. 11]

Key2=RSAES-OAEP.decrypt(kPrivDev,encrypted_Key2) (11)

Since the encryption key Key2 is encrypted with the public key kPubDev by RSA public key encryption, the encryption key Key2 can be decrypted with the private key kPrivDev corresponding to the public key kPubDev.

For example, in the example of the IM license indicated in FIG. 6, the inference model is permitted to be used continuously within the expiration period of the IM license.

Accordingly, the license acquisition unit 92 supplies the encryption key Key1 and the encryption key Key2, which are obtained by decryption, to a non-volatile memory such as the recording unit 94, and stores (records) them safely so that the inference model can be used for inference execution during the expiration period.

In addition, security measures are taken to prevent the inference model from being leaked to the outside when the inference model is decrypted and stored in the IoT device 43 and the inference is executed using the inference model.

For example, a central processing unit (CPU) having a trusted execution environment (TEE) function is used as a processor that implements blocks such as the license acquisition unit 92, the decryption unit 96, and the inference engine 97, to execute software in a secure environment, so that it is possible to implement security measures to prevent the inference model from being leaked to the outside. Only the public key kPubDev for the IoT device 43 with such security measures is registered with the PKI described above.

In step S60, the inference engine 97 performs inference by performing arithmetic processing using the inference model based on the inference model supplied from the decryption unit 96 and image data as input data supplied from the image sensor 95.

The inference engine 97 uses the inference model licensed by the IM license to perform inference on the image data generated by the image sensor 95 and the like, and then supplies the resulting IR data (inference result) to the encryption unit 98.

In step S61, the license acquisition unit 92 generates an identifier eid for identifying the derived encryption key Key3 generated from the encryption key Key2 obtained in step S59.

For example, the license acquisition unit 92 generates an identifier eid based on the “use start time and date” for the IM license, and the derivation cycle of the derived encryption key Key3, that is, the “key derivation interval” in the inference result encryption rule information for the IM license. By doing so, a different derived encryption key Key3 can be generated for each identifier eid.

Note that the identifier eid may be a random value, or the time and date of key derivation may be specified as the identifier eid so that the period of derivation of the derived encryption key Key3 can be identified.

The license acquisition unit 92 supplies the encryption key Key2 extracted from the IM license and the identifier eid to the key derivation unit 93, and instructs the key derivation unit 93 to derive a derived encryption key Key3.

In step S62, the key derivation unit 93 calculates an encryption equation represented in the following Equation (12) based on the encryption key Key2 and the identifier eid, which are supplied from the license acquisition unit 92, to perform key derivation using the hash function sha256 to generate (derive) a derived encryption key Key3.

[Math. 12]

Key3=hash_hdkf(‘sha256’,Key2,32,‘key2—encrypt ion’,eid) (12)

Here, hash_hdkf in Equation (12) represents a derived function defined by rfc5869; ‘key2_encryption’ is a salt, which may be any value.

By the calculation of Equation (12), a derived encryption key Key3, which is a derived key, is generated from the encryption key Key2, which is a root key, according to the inference result encryption rule information for the IM license, and this derived encryption key Key3 is used to encrypt the IR data.

The key derivation unit 93 supplies the resulting derived encryption key Key3 to the license acquisition unit 92.

In response to this, the license acquisition unit 92 supplies the derived encryption key Key3 supplied from the key derivation unit 93 and the identifier eid of the derived encryption key Key3 to the encryption unit 98.

In step S63, the encryption unit 98 encrypts the IR data supplied from the inference engine 97 based on the derived encryption key Key3 supplied from the license acquisition unit 92 to generate encrypted IR data.

For example, the encryption unit 98 calculates the following Equation (13) based on the derived encryption key Key3 and the IR data (IRdata) to perform encryption using an AES common key encryption function AES.Encrypt and thus to obtain encrypted IR data Enc_IRdata.

[Math. 13]

Enc_IRdata=AES.Encrypt(Key3,IRdata) (13)

The encryption unit 98 records (stores) the identifier cid, the public key kPubDev, and the identifier eid as parameters into a file of the obtained encrypted IR data, and supplies the file of the encrypted IR data to the communication unit 91.

The license acquisition unit 92 and the key derivation unit 93 of the IoT device 43 generate a new derived encryption key Key3 with the identifier eid changing according to the derivation cycle indicated by the “key derivation interval” for the IM license.

The encryption unit 98 uses the derived encryption key Key3 supplied from the license acquisition unit 92 to encrypt the IR data (inference result). To encrypt this IR data, the same derived encryption key Key3 is used during the derivation period indicated by the “key derivation interval” for the IM license.

In step S64, the communication unit 91 transmits the encrypted IR data supplied from the encryption unit 98, more specifically, the file of the encrypted IR data including the identifier cid, the public key kPubDev, and the identifier eid, to the service server 44 via the network or the like, and then the inference execution processing ends.

Note that the timing of the IoT device 43 acquiring the IM license and the timing of the IoT device 43 decoding the inference model may be any timing such as before shipment of the IoT device 43 or when inference is executed after shipment of the IoT device 43.

In addition, the timing of execution of inference using the inference model may be any timing as long as it is after the inference model is decoded.

As described above, the IoT device 43 acquires the IM license, decrypts the inference model, and encrypts the IR data obtained by inference according to the IM license. The license provider 42 generates the IM license including the inference result encryption rule information in response to a request from the IoT device 43, and transmits the generated IM license to the IoT device 43.

By doing so, not only the inference model but also the inference result can appropriately be protected by the IM license in accordance with the licensing rule Rules.

### Configuration Example of Service Server

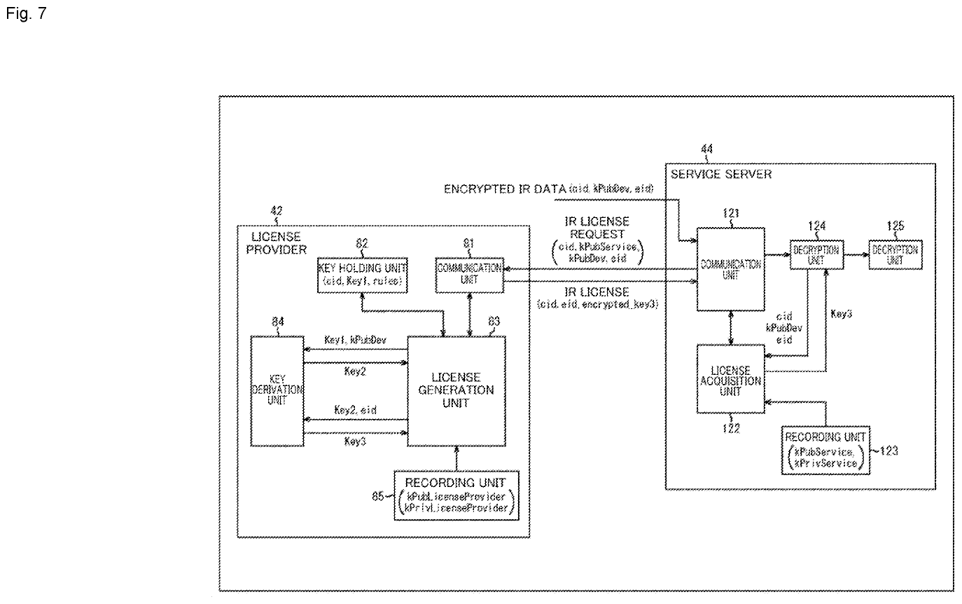

The service server 44 is configured as illustrated in FIG. 7, for example. In FIG. 7, portions corresponding to those of FIG. 3 are denoted by the same reference numerals, and description of the portions will be omitted.

The service server 44 includes a communication unit 121, a license acquisition unit 122, a recording unit 123, a decryption unit 124, and an analysis unit 125.

The communication unit 121 receives the encrypted IR data from the IM provider 41, supplies the received encrypted IR data to the decryption unit 124, receives the IR license from the license provider 42, and supplies the received IR license to the license acquisition unit 122.

The license acquisition unit 122 acquires the IR license from the license provider 42 via the communication unit 121, generates a derived encryption key Key3 from the encryption key Key2 extracted from the IR license, and supplies the derived encryption key Key3 to the decryption unit 124.

The recording unit 123 records a public key kPubService and a private key kPrivService, which make a pair of keys for public key cryptography for the service server 44, and supplies the public key kPubService and the private key kPrivService to the license acquisition unit 122 as necessary. The public key kPubService is for authentication of the service server 44 and is managed in the PM described above.

The decryption unit 124 performs decryption processing on the encrypted IR data supplied from the communication unit 121 based on the derived encryption key Key3 supplied from the license acquisition unit 122, and supplies the resulting IR data to the analysis unit 125.

The analysis unit 125 performs analysis processing such as big data analysis for services to be provided by the cloud including the service server 44 on a plurality of pieces of IR data supplied from the decryption unit 124.

### <Description of IR Data Use Processing and IR Data Licensing Processing>

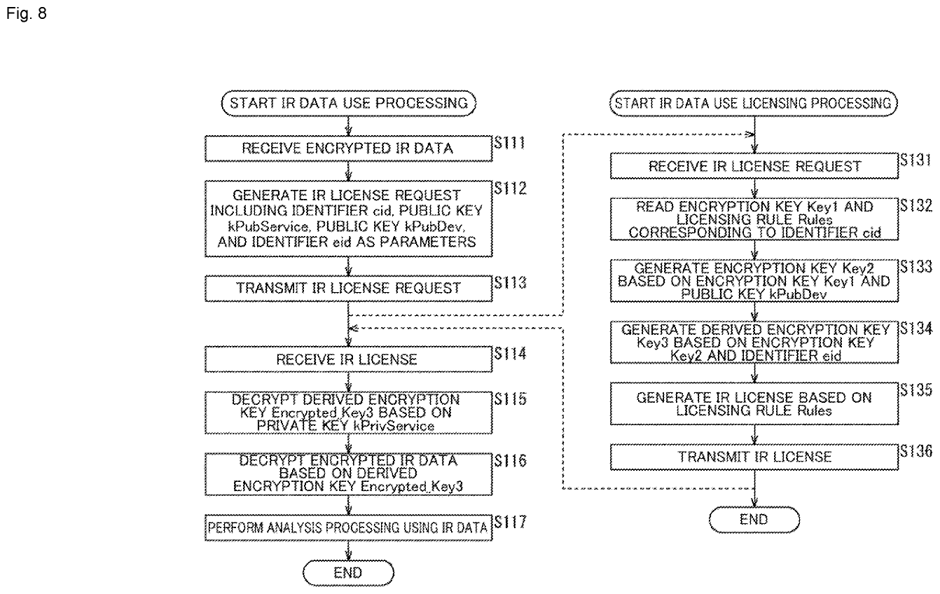

Next, IR data use processing performed by the service server 44 and IR data licensing processing performed by the license provider 42 will be described with reference to the flowchart of FIG. 8.

For example, when the processing of step S64 in FIG. 5 is performed and the encrypted IR data is transmitted from the IoT device 43 to the service server 44, the service server 44 starts the IR data use processing.

In step S111, the communication unit 121 receives the encrypted IR data transmitted from the IoT device 43 and supplies the received encrypted IR data to the decryption unit 124.

The decryption unit 124 reads (extracts) the identifier cid, the public key kPubDev, and the identifier eid from the encrypted IR data supplied from the communication unit 121, more specifically from the file of the encrypted IR data, and supplies them to the license acquisition unit 122.

In step S112, the license acquisition unit 122 generates an IR license request including the identifier cid, the public key kPubService, the public key kPubDev, and the identifier eid as parameters, and supplies the IR license request to the communication unit 121.

Specifically, the license acquisition unit 122 reads the public key kPubService for the service server 44 from the recording unit 123.

The license acquisition unit 122 then generates a request to request an IR license, including the identifier cid, the public key kPubDev, and the identifier eid, which are supplied from the decryption unit 124, and including the public key kPubService read from the recording unit 123, and supplies the request to the communication unit 121.

In step S113, the communication unit 121 transmits the IR license request supplied from the license acquisition unit 122 to the license provider 42 via the network or the like.

In response to this, the license provider 42 starts the IR data licensing processing to perform processing of step S131.

Accordingly, in step S131, the communication unit 81 receives the IR license request transmitted from the service server 44 and supplies the received IR license request to the license generation unit 83.

The license generation unit 83 extracts (reads) the identifier cid, the public key kPubService, the public key kPubDev, and the identifier eid from the request supplied from the communication unit 81.

In step S132, the license generation unit 83 reads from the key holding unit 82 the encryption key Key1 and the licensing rule Rules, which correspond to the identifier cid extracted from the IR license request.

The license generation unit 83 also supplies the encryption key Key1 and the public key kPubDev to the key derivation unit 84 and instructs the key derivation unit 84 to generate (derive) an encryption key Key2.

In step S133, the key derivation unit 84 calculates the following Equation (14) based on the encryption key Key1 and the public key kPubDev, which are supplied from the license generation unit 83, to generate an encryption key Key2, and transmits the encryption key Key2 to the license generation unit 83. Equation (14) is for the same calculation as Equation (3) described above.

[Math. 14]

Key2=hash_hdkf(‘sha256’,Key1,32,‘key1-encryption’,kPubDev) (14)

The license generation unit 83 supplies the encryption key Key2 supplied from the key derivation unit 84 and the identifier eid extracted from the IR license request to the key derivation unit 84, and instructs the key derivation unit 84 to generate (derive) a derived encryption key Key3.

In step S134, the key derivation unit 84 calculates the following Equation (15) based on the encryption key Key2 and the identifier eid, which are supplied from the license generation unit 83, to perform key derivation, generates (derives) a derived encryption key Key3, and supplies the resulting derived encryption key Key3 to the license generation unit 83. Equation (15) is for the same calculation as Equation (12) described above.

[Math. 15]

Key3=hash_hdkf(‘sha256’,Key2,32,‘key2-encryption’,eid) (15)

In step S135, the license generation unit 83 generates an IR license based on the licensing rule Rules and supplies the IR license to the communication unit 81.

As a specific example, a case will now be described in which the IR license indicated in FIG. 6 is generated.

In the example indicated in FIG. 6, the IR license includes the “inference result license information” and the “license signature”.

The license generation unit 83 sets as the “inference model ID” in the “inference result license information” the identifier cid extracted from the IR license request, in other words, the identifier cid (inference model ID) included in the licensing rule Rules read from the key holding unit 82.

The license generation unit 83 sets the public key kPubDev extracted from the IR license request as the “inference result generator public key” in the “inference result license information”, and sets the identifier eid extracted from the IR license request as the “derived key ID” in the “inference result license information”.

The license generation unit 83 also sets the public key kPubService for the service server 44, which is the user of the IR data, extracted from the IR license request as the “user public key”.

For example, the license generation unit 83 sets as the “use start time and date” the time and date when the IR license was issued, and sets as the “use end time and date” the time and date calculated from the “use start time and date” and the “expiration period” in the “inference result rule information” in the licensing rule Rules. In this example, since the “expiration period” in the licensing rule Rules is 1 year, the “use end time and date” is set to be 1 year after the “use start time and date”.

Further, the license generation unit 83 performs encryption for public key encryption on the derived encryption key Key3 supplied from the key derivation unit 84 based on the public key kPubService for the service server 44 extracted from the IR license request.

For example, the license generation unit 83 calculates the following Equation (16) to encrypt the derived encryption key Key3 using the RSA public key encryption specified in Rfc 8017, and thus to obtain a value of the encrypted derived encryption key Key3, Encrypted_Key3.

[Math. 16]

Encrypted_Key3=RSAES-OAEP.encrypt(kPubService,Key3) (16)

In the calculation of Equation (16), the public key kPubService specified in the IR license request is used as the encryption key for public key cryptography. As a result, only the service server 44, which is the user of the IR license, can use the derived encryption key Key3 to decrypt the IR data for use.

The license generation unit 83 sets the value of the encrypted derived encryption key Key3, Encrypted_Key3, that is, the encrypted derived encryption key Encrypted_Key3 as the “inference result encryption key” in the “inference result license information” for the IR license.

The IR license includes a “license signature”, and the license generation unit 83 generates a “license provider public key” and a “license provider signature” that are to be stored in the “license signature”.

Specifically, the license generation unit 83 reads from the recording unit 85 the public key kPubLicenseProvider for the license provider 42 that issues the IR license, and sets the public key kPubLicenseProvider as the “license provider public key”. The public key kPubLicenseProvider is paired with the private key kPrivLicenseProvider for the license provider 42 used in the “license provider signature”.

The license generation unit 83 also generates a public key encryption signature Sign for verifying and authenticating the authenticity of the “inference result license information” for the IR license, and sets the public key encryption signature Sign as the “license provider signature” for the IR license. As a key for this signature, the private key kPrivLicenseProvider for the license provider 42 that has issued the IR license is used.

Specifically, the license generation unit 83 sets as Message the value obtained by concatenating all the parameters described in the “inference result license information” included in the IR license, and calculates the following Equation (17) based on Message to obtain a hash value LicenseHash.

[Math. 17]

LicenseHash=sha256(Message) (17)

The license generation unit 83 also calculates the following Equation (18) to sign the hash value LicenseHash with the private key kPrivLicenseProvider to obtain the public key encryption signature Sign.

[Math. 18]

Sign=ECDSA.sign(kPrvLicenseProvider,LicenseHash) (18)

When the IR license is generated as described above, the license generation unit 83 supplies the generated IR license to the communication unit 81.

In step S136, the communication unit 81 transmits the IR license supplied from the license generation unit 83 to the service server 44 via the network or the like, and then the IR data licensing processing ends.

When the IR license is transmitted, the service server 44 performs processing of step S114.

In step S114, the communication unit 121 receives the IR license transmitted from the license provider 42 and supplies the received IR license to the license acquisition unit 122.

In response to this, the license acquisition unit 122 verifies the public key kPubLicenseProvider and the public key encryption signature Sign, which are included in the IR license supplied from the communication unit 121.

Specifically, first, the license acquisition unit 122 authenticates (verifies) the public key kPubLicenseProvider for the license provider 42 included in the IR license in the PKI.

After that, the license acquisition unit 122 sets as Message the value obtained by concatenating all the parameters described in the “inference result license information” included in the IR license indicated in FIG. 6, and performs the same calculation as Equation (17) to obtain a hash value LicenseHash.

The license acquisition unit 122 also performs the same calculation as Equation (8) based on the hash value LicenseHash and based on the public key cryptographic signature Sign and the public key kPubLicenseProvider, which are included in the IR license, to verify the public key cryptographic signature Sign.

The IR license also includes the “inference result generator public key”, that is, the public key kPubDev for the IoT device 43 that has generated the inference result (IR data), and the “inference model ID”. Therefore, the license acquisition unit 122 can verify which IoT device 43 generated the IR data using which inference model.

In step S115, the license acquisition unit 122 reads the private key kPrivService from the recording unit 123, and decrypts the encrypted derived encryption key Key3 (encrypted derived encryption key Encrypted_Key3) included in the IR license, based on the private key kPrivService.

For example, when the derived encryption key Key3 has been encrypted using the RSA (public key cryptography), the license acquisition unit 122 calculates the following Equation (19) based on the encrypted derived encryption key Encrypted_Key3 and the private key kPrivService to decrypt the derived encryption key Key3.

[Math. 19]

Key3=EREAES-OAEP.decrypt(kPrivService,Encrypted_Key3) (19)

The license acquisition unit 122 supplies the resulting derived encryption key Key3 to the decryption unit 124.

In step S116, the decryption unit 124 decrypts, based on the derived encryption key Key3 supplied from the license acquisition unit 122, the encrypted IR data supplied from the communication unit 121 in step S111, that is, the encrypted IR data, and supplies the resulting IR data to the analysis unit 125.

For example, the decryption unit 124 calculates the following Equation (20) based on the derived encryption key Key3 and the encrypted IR data Enc_IRdata to obtain IR data (IRdata). Equation (20) is for decryption for AES common key encryption.

[Math. 20]

IRdata=AES.Decrypt(key3,Enc_IRdata) (20)

In the service server 44, until the expiration period starting from the “use start time and date” in the IR license is reached, that is, until the “use end time and date” is reached, the IR data is permitted to be decrypted using the derived encryption key Key3 obtained from the IR license.

For example, in the case where the identifier eid included in the file of the encrypted IR data has been changed because the expiration period has passed, that is, in the case where the identifier eid included in the encrypted IR data differs from the identifier eid included in the IR license, the license acquisition unit 122 is required to acquire the IR license from the license provider 42 again.

In step S117, the analysis unit 125 performs analysis processing such as big data analysis using the IR data supplied from the decryption unit 124, and then the IR data use processing ends.

For example, in a case where big data analysis or the like is performed, since it may be difficult to make a secure execution environment like the TEE as in the case of the IoT device, security measures are required to be taken for the service server 44 so as not to leak the IR data to the outside.

As described above, the service server 44 acquires an IR license from the license provider 42 and decrypts the corresponding IR data according to the IR license. On the other hand, the license provider 42 issues the IR license in accordance with a licensing rule Rules.

By doing so, not only the inference model but also the IR data (inference result) can be appropriately protected in accordance with the licensing rule Rules defined by the IM provider 41, which is a provider of the inference model.

### Other Modification Examples

According to the present technology described above, an inference model obtained by machine learning and an inference result (IR data) obtained using the inference model can be encrypted and transmitted.

Examples of use cases for the present technology may include uploading inference results from large scale integration (LSI) such as an image sensor with an inference engine installed or from an IoT device with an inference engine installed to a service on cloud.

Using the present technology, in such use cases, it is possible to prevent inference models and inference results from being leaked to third parties or being tampered with by third parties.

According to the present technology, it is possible to license, in accordance with a licensing rule specified by a provider of an inference model, the inference model as well as an inference result generated using the inference model. In other words, it is also possible to manage the rights for the inference result in accordance with the licensing rule.

Further, it is possible for a user of the inference result (IR data) to verify, based on an IR license, which IoT device (and inference engine) has generated the inference result by using which inference model, and thus to safely and securely use the inference result.

In addition, the present technology is not limited to the above-described embodiments, and of course other embodiments are possible.

For example, in the above-described embodiments, the case has been described as an example in which the IoT device 43 obtains an inference model and then requests an IM license for the inference model.

However, for example, if the IoT device 43 to use the IM license is identified, that is, if the public key kPubDev for the IoT device 43 is identified, the inference model and the IM license for that inference model can be introduced to the IoT device 43 at once.

Specifically, for example, it is possible to sell the IoT device 43 with the inference model and the IM license having been installed in the IoT device 43 at the time of shipment from the factory.

Similarly, for the inference result, by specifying the period of time available for the inference result before the service server 44 obtains the inference result is obtained, that is, before the inference is executed, the service server 44 can obtain the IR license in advance.

In addition, for the acquisition of IR license, IR licenses for a plurality of use periods for IR data (inference results) can be obtained in advance at once.

Furthermore, although an example has been described above in which the IoT device 43 encrypts the IR data, for example, the encryption unit 98 can further encrypt input data such as image data obtained by the image sensor 95 to protect the data.

In such a case, not only the encrypted IR data but also the encrypted image data are transmitted to, for example, a service on cloud such as the service server 44, and used for high-performance machine learning, big data analysis, and the like.

In this case, both the IR data and the image data (sensor data) as the input data can be encrypted with the same encryption key.

However, the encryption rule information corresponding to the “inference result encryption rule information” described in the IM license may be prepared separately for the IR data and the image data so that each data is encrypted with a different encryption key. By doing so, it is possible to grant licenses for using the IR data and the image data based on separate licensing rules. Only the input data may be encrypted, that is, the IR data (inference result) may be not encrypted. In such a case, the licensing rule Rules and the IM license may include licensing rule information and encryption rule information only for the input data, respectively, and the license provider 42 may generate (issue) a license for licensing the input data as in the case of the IR license. In addition, the encryption condition for the input data is not limited to a predetermined time (period), such as every day, as in the case of the IR data, and may be any condition, such as generating a derived encryption key Key3 for each input data.

Application examples of the information processing system to which the present technology is applied may include an example in which the information processing system is combined with a blockchain.

Recently, a blockchain is attracting attention as a technology for safe and secure data transactions in a consortium consisting of multiple organizations.

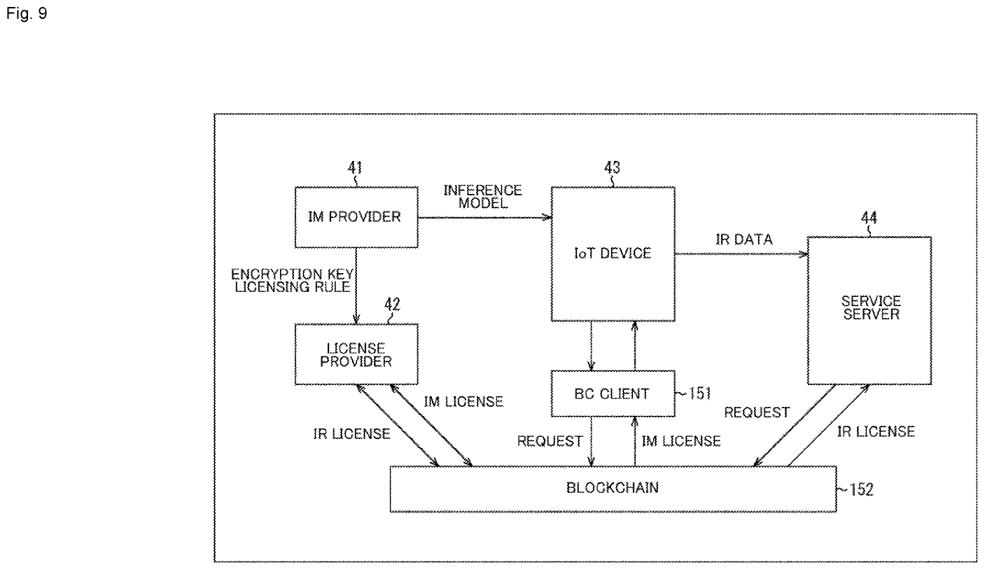

For example, when the information processing system illustrated in FIG. 2 and a blockchain are combined, the information processing system is configured as illustrated in FIG. 9. In FIG. 9, portions corresponding to those of FIG. 2 are denoted by the same reference numerals, and description of the portions will be appropriately omitted.

The information processing system illustrated in FIG. 9 includes the IM provider 41, the license provider 42, the IoT device 43, the service server 44, a blockchain (BC) client 151 and a blockchain 152.

In this example, the blockchain 152 is, for example, a consortium-type blockchain made up of a plurality of devices.

The BC client 151 is an information processing device that can be connected to (can access) the blockchain 152, and exchanges information between the IoT device 43 and the blockchain 152 via the BC client 151.

Furthermore, in this example, the license provider 42 and the service server 44 function as BC clients that can be connected directly to the blockchain 152.

In such an information processing system, the acquisition of an IM license or an IR license is performed via the blockchain 152. The information processing system can also associate licenses with cryptocurrency payments, record transaction histories on the blockchain 152, and audit unauthorized use of licenses.

Furthermore, in the information processing system illustrated in FIG. 2, public key management similar to the Web PKI and DRM is assumed as the PKI. However, in such a mechanism, if an unauthorized IoT device 43 or service server 44 uses a license, it is difficult to revoke the public key for the unauthorized person and then effectively inform the license provider 42 or the license user of that revocation.

By contrast, in the information processing system illustrated in FIG. 9, the blockchain 152 implements a PKI for managing public keys so that registration and revocation of the public keys for license users can be detected.

In the information processing system, the acquisition of all licenses such as IM licenses and IR licenses is performed via the blockchain 152. Therefore, it is possible to reject a license request from a user for which the public key has been revoked in accordance with a smart contract, thereby enhancing the security of the entire information processing system.

The flow of processing to use an inference model and IR data in the information processing system of FIG. 9 will be described below.

In the information processing system, a transaction is issued to the blockchain 152 by a BC client having a public key pair, that is, a pair of public and private keys.

In this example, the license provider 42 and the service server 44 each include a BC client, that is, each function as a BC client as described above, while the IoT device 43 does not have the function as the BC client.

Therefore, the IoT device 43 has application software that implements the BC client externally, that is, the IoT device 43 is connected to the blockchain 152 via the BC client 151, which is an external device.

First, the IM provider 41 registers an inference model and the corresponding licensing rule Rules with the license provider 42. The IM provider 41 then transmits its encrypted inference model to the IoT device 43.

Next, the BC client 151 acquires the public key kPubDev for the IoT device 43 from the IoT device 43 using the inference model.

The BC client 151 acquires the identifier cid included in a file of the encrypted inference model from the IoT device 43, generates an IM license request including the identifier cid and the public key kPubDev, and stores the IM license request into a transaction.

The BC client 151 then transmits (supplies) the transaction including the generated request to the blockchain 152.

In response to this, the blockchain 152 records the transaction received from the BC client 151 and authenticates the public key kPubDev included in the IM license request, in accordance with a smart contract.

After that, the blockchain 152 also transmits the IM license request from the BC client 151 to the license provider 42 in accordance with the smart contract.

When the license provider 42 receives the IM license request from the blockchain 152, the license provider 42 generates an IM license according to the request and transmits (supplies) the transaction in which the IM license is stored to the blockchain 152.

The blockchain 152 records the transaction including (storing) the IM license and received from the license provider 42 and transmits the IM license to the BC client 151.

In response to this, the BC client 151 receives the IM license from the blockchain 152 and supplies the received IM license to the IoT device 43, and accordingly the IoT device 43 installs the inference model based on the IM license, that is, decrypts the inference model.

After that, the IoT device 43 performs inference on input data using the inference model and obtains an inference result (IR data). The IoT device 43 also encrypts the inference result (IR data) and transmits (sends) the resulting encrypted IR data to the service server 44.

When the service server 44 receives the encrypted IR data, the service server 44 uses its own BC client to generate a transaction including an IR license request and transmits the transaction to the blockchain 152.

The IR license request includes the identifier cid, the public key kPubService, the public key kPubDev, and the identifier eid as parameters as described above.

The blockchain 152 records the transaction received from the service server 44 and authenticates the public key kPubService included in the IR license request, in accordance with the smart contract.

After that, the blockchain 152 transmits the IR license from the service server 44 to the license provider 42 in accordance with the smart contract.

When the license provider 42 receives the IR license request from the blockchain 152, the license provider 42 generates an IR license according to the request and transmits (supplies) the transaction in which the IR license is stored to the blockchain 152.

The blockchain 152 records the transaction including the IR license and received from the license provider 42 and transmits the IR license to the service server 44.

When the service server 44 receives the IR license from the blockchain 152, the service server 44 decrypts the IR data according to the IR license and uses the IR data for analysis processing such as big data analysis. In this case, other IR data may be used for the same IR license depending on the conditions of use and the like stipulated in the IR license.

As described with reference to FIG. 9, the present technology can also be applied to an information processing system using a blockchain, and as in the case of the information processing system illustrated in FIG. 2, the rights of both the inference model and the inference result can appropriately be protected.

As described above, according to the present technology, the license provider 42 generates, from an encryption key Key1 and a licensing rule Rules for the inference model, an IM license including the encryption key Key1 serving as the decryption key for the inference model and an IR license including a derived encryption key Key3 serving as the decryption key for the inference result.

By doing so, the inference model and the inference result can be decrypted based on the licensing rule Rules so that the inference model and the inference result can be licensed. In other words, it is possible to license, in accordance with the licensing rule Rules specified by the IM provide 41, which is a provider of an inference model, the inference model as well as the inference result generated using the inference model, and to manage the rights of the inference model and the inference result.

In addition, according to the present technology, the IM license issued for each inference engine (IoT device 43) includes the encryption key Key1 for decrypting the inference model and a root encryption key (encryption key Key2) for encrypting the inference result. The inference engine encrypts the inference result based on the derived encryption key Key3 of the encryption key Key2.

Therefore, even if the IoT device 43 (inference engine) does not have a communication function or even if the IoT device 43 is in an environment where it cannot communicate, by acquiring the IM license, the inference model can be used and the derived encryption key Key3 can be generated to encrypt the inference result.

Moreover, there is no need to deploy a server for issuing a license for the inference result separately from the license provider 42 for issuing a license for the inference model, and thus, without access to such a server, the IoT device 43 can encrypt the inference result and provide the encrypted inference result to the service server 44.

Since the IoT device 43 does not need to acquire the encryption key Key2 from the license provider 42 or register the encryption key Key2 with the license provider 42 each time the IoT device 43 encrypts the inference result, there is no communication overhead.

Furthermore, in the present technology, the inference engine (IoT device 43) encrypts the inference result with the derived encryption key Key3 generated according to the encryption condition(s) based on the encryption key Key2. The license provider 42 issues an IR license for decrypting the inference result in accordance with the licensing rule Rules for the inference model.

Thus, the generated inference result can be licensed, for example, on a period basis. In this way, for example, a licensing period can be divided into short periods so that value to the use of the inference result can be billed in smaller units. In addition, since cloud servers are at high risk of being hacked, changing the key used to decrypt the inference result for each of such short periods of time is effective as a countermeasure against hacking.

### Configuration Example of Computer

The above-described series of processing can also be performed by hardware or software. In the case where the series of processes is executed by software, a program that configures the software is installed on a computer. Here, the computer includes, for example, a computer built in dedicated hardware, a general-purpose personal computer on which various programs are installed to be able to execute various functions, and the like.

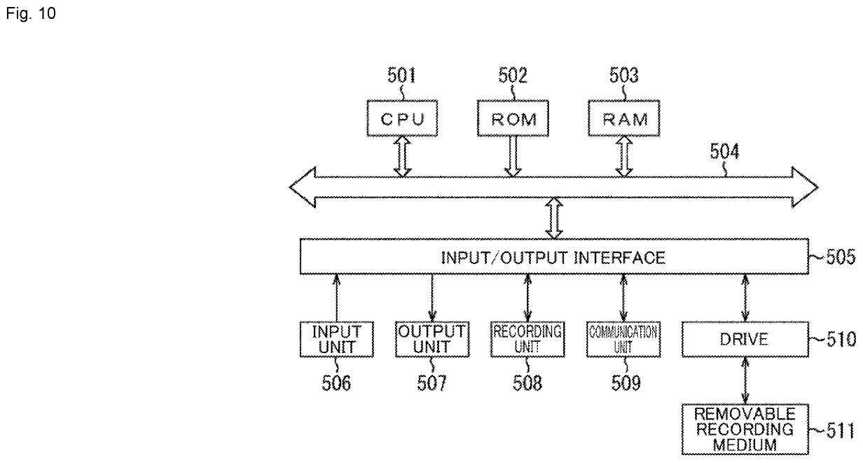

FIG. 10 is a block diagram illustrating a configuration example of hardware of a computer that executes the series of processing described above using a program.

In the computer, a CPU 501, a read-only memory (ROM) 502, and a random access memory (RAM) 503 are connected to one another via a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, and an imaging element. The output unit 507 includes a display and a speaker. The recording unit 508 includes a hard disk and a nonvolatile memory. The communication unit 509 includes a network interface. The drive 510 drives a removable recording medium 511 such as a magnetic disk, an optical disc, a magneto-optical disk, or a semiconductor memory.

In the computer configured thus, the CPU 501 loads, for example, a program recorded in the recording unit 508 into the RAM 503 through the input/output interface 505 and the bus 504 and executes the program, so that the series of processing is performed.

The program to be executed by the computer (the CPU 501) can be provided in such a manner as to be recorded on, for example, the removable recording medium 511 serving as a packaged medium. The program can also be provided through a wired or wireless transmission medium such as a local area network, the Internet, or digital satellite broadcasting.

In the computer, the program can be installed on the recording unit 508 through the input/output interface 505 by loading the removable recording medium 511 into the drive 510. Furthermore, the program can be received by the communication unit 509 through a wired or wireless transfer medium and installed on the recording unit 508. In addition, the program can be installed in advance on the ROM 502 or the recording unit 508.

Note that the program executed by a computer may be a program that performs processing chronologically in the order described in the present specification or may be a program that performs processing in parallel or at a necessary timing such as a called time.

In addition, embodiments of the present technology are not limited to the above-described embodiments, and various modifications can be made without departing from the scope and spirit of the present technology.

For example, the present technique may be configured as cloud computing in which a plurality of devices share and cooperatively process one function via a network.

In addition, each step described in the above flowchart can be executed by one device or executed in a shared manner by a plurality of devices.

Furthermore, in a case where a plurality of kinds of processing are included in a single step, the plurality of kinds of processing included in the single step may be executed by one device or by a plurality of devices in a shared manner.

The present technique can also be configured as follows.

(1)

An information processing system including: a license provider that generates a license for an inference model; and a device that uses the inference model, wherein the license provider includes
a license generation unit that generates the license including a first key and a second key based on licensing rule information that indicates a rule for licensing the inference model and either an inference result obtained by inference in response to input data to the inference model or the input data, the first key being for decrypting the inference model encrypted, the second key being for encrypting the inference result or the input data; and
a first communication unit that transmits the license to the device,
and
the device includes
a second communication unit that receives the license;
a decryption unit that decrypts the encrypted inference model based on the first key included in the license; and
an inference engine that performs the inference based on the inference model.
   (2)

The information processing system according to (1), wherein the device further includes
an encryption unit that encrypts the inference result obtained by the inference or the input data based on the second key included in the license.
   (3)

The information processing system according to (2), wherein
the license generation unit generates the license including encryption rule information indicating an encryption condition for the inference result or the input data, and
the encryption unit encrypts the inference result or the input data based on a third key generated based on the second key and the encryption rule information included in the license.
   (4)

The information processing system according to (3), wherein the encryption condition is a condition that the inference result or the input data is encrypted with the third key generated for each predetermined period or for each inference result or input data.

(5)

The information processing system according to any one of (1) to (4), wherein the first key and the second key included in the license are encrypted with a public key for public key cryptography for the device, and the encrypted first key and second key are decrypted with a private key for the device corresponding to the public key.

(6)

The information processing system according to any one of (1) to (5), wherein the second communication unit receives the license from the license provider via a blockchain.

(7)

An information processing device including;
a communication unit that receives from a license provider a license including a first key and a second key, the first key being for decrypting an encrypted inference model, the second key being for encrypting an inference result obtained by inference in response to input data to the inference model or for encrypting the input data;
a decryption unit that decrypts the encrypted inference model based on the first key included in the license; and
an inference engine that performs the inference based on the inference model.
   (8)

The information processing device according to (7), further including an encryption unit that encrypts the inference result obtained by the inference or the input data based on the second key included in the license.

(9)

The information processing device according to (8), wherein
the license includes encryption rule information indicating an encryption condition for the inference result or the input data, and
the encryption unit encrypts the inference result or the input data based on a third key generated based on the second key and the encryption rule information included in the license.
   (10)

The information processing device according to (9), wherein the encryption condition is a condition that the inference result or the input data is encrypted with the third key generated for each predetermined period or for each inference result or input data.

(11)

The information processing device according to any one of (7) to (10), wherein the first key and the second key included in the license are encrypted with a public key for public key cryptography for the information processing device, and the encrypted first key and second key are decrypted with a private key for the information processing device corresponding to the public key.

(12)

The information processing device according to any one of (7) to (10), wherein the communication unit receives the license from the license provider via a blockchain.

(13)

An information processing method performed by an information processing device, the information processing method comprising:
receiving from a license provider a license including a first key and a second key, the first key being for decrypting an encrypted inference model, the second key being for encrypting an inference result obtained by inference in response to input data to the inference model or for encrypting the input data;
decrypting the encrypted inference model based on the first key included in the license; and
performing the inference based on the inference model.
   (14)

An information processing device including;
a license generation unit that generates the license including a first key and a second key based on licensing rule information that indicates a rule for licensing an inference model and either an inference result obtained by inference in response to input data to the inference model or the input data, the first key being for decrypting the inference model encrypted, the second key being for encrypting the inference result or the input data; and
a communication unit that transmits the license to a device that uses the inference model.
   (15)

The information processing device according to (14), wherein the license generation unit generates the license including encryption rule information indicating an encryption condition for the inference result or the input data.

(16)

The information processing device according to (15), wherein the encryption condition is a condition that the inference result or the input data is encrypted with a third key generated for each predetermined period or for each inference result or input data.

(17)

The information processing device according to (16), wherein the license generation unit further generates a license for the inference result or the input data based on the licensing rule information, the license including the third key.

(18)

The information processing device according to any one of (14) to (17), further including a key derivation unit that generates the second key based on the first key and a public key for public key cryptography for the device.

(19)

The information processing device according to (18), wherein the license generation unit generates the license including the first key encrypted with the public key and the second key encrypted with the public key.

(20)

An information processing method performed by an information processing device, the information processing method comprising:
generating the license including a first key and a second key based on licensing rule information that indicates a rule for licensing the inference model and either an inference result obtained by inference in response to input data to the inference model or the input data, the first key being for decrypting the inference model encrypted, the second key being for encrypting the inference result or the input data; and
transmitting the license to a device that uses the inference model.

### REFERENCE SIGNS LIST

41 IM provider
42 License provider
43 IoT device
44 Service server
81 Communication unit
82 Key holding unit
83 License generation unit
84 Key derivation unit
91 Communication unit
92 License acquisition unit
93 Key derivation unit
95 Image sensor
96 Decryption unit
97 Inference engine
98 Encryption unit
152 Blockchain

1. An information processing system comprising: a license provider that generates a license for an inference model; and a device that uses the inference model, wherein
the license provider includes a license generation unit that generates the license including a first key and a second key based on licensing rule information that indicates a rule for licensing the inference model and either an inference result obtained by inference in response to input data to the inference model or the input data, the first key being for decrypting the inference model encrypted, the second key being for encrypting the inference result or the input data; and
a first communication unit that transmits the license to the device,
and
the device includes
a second communication unit that receives the license;
a decryption unit that decrypts the encrypted inference model based on the first key included in the license; and
an inference engine that performs the inference based on the inference model.

2. The information processing system according to claim 1, wherein the device further includes
an encryption unit that encrypts the inference result obtained by the inference or the input data based on the second key included in the license.

3. The information processing system according to claim 2, wherein
the license generation unit generates the license including encryption rule information indicating an encryption condition for the inference result or the input data, and
the encryption unit encrypts the inference result or the input data based on a third key generated based on the second key and the encryption rule information included in the license.

4. The information processing system according to claim 3, wherein the encryption condition is a condition that the inference result or the input data is encrypted with the third key generated for each predetermined period or for each inference result or input data.

5. The information processing system according to claim 1, wherein the first key and the second key included in the license are encrypted with a public key for public key cryptography for the device, and the encrypted first key and second key are decrypted with a private key for the device corresponding to the public key.

6. The information processing system according to claim 1, wherein the second communication unit receives the license from the license provider via a blockchain.

7. An information processing device comprising:
a communication unit that receives from a license provider a license including a first key and a second key, the first key being for decrypting an encrypted inference model, the second key being for encrypting an inference result obtained by inference in response to input data to the inference model or for encrypting the input data;
a decryption unit that decrypts the encrypted inference model based on the first key included in the license; and
an inference engine that performs the inference based on the inference model.

8. The information processing device according to claim 7, further comprising an encryption unit that encrypts the inference result obtained by the inference or the input data based on the second key included in the license.

9. The information processing device according to claim 8, wherein
the license includes encryption rule information indicating an encryption condition for the inference result or the input data, and
the encryption unit encrypts the inference result or the input data based on a third key generated based on the second key and the encryption rule information included in the license.

10. The information processing device according to claim 9, wherein the encryption condition is a condition that the inference result or the input data is encrypted with the third key generated for each predetermined period or for each inference result or input data.

11. The information processing device according to claim 7, wherein the first key and the second key included in the license are encrypted with a public key for public key cryptography for the information processing device, and the encrypted first key and second key are decrypted with a private key for the information processing device corresponding to the public key.

12. The information processing device according to claim 7, wherein the communication unit receives the license from the license provider via a blockchain.

13. An information processing method performed by an information processing device, the information processing method comprising:
receiving from a license provider a license including a first key and a second key, the first key being for decrypting an encrypted inference model, the second key being for encrypting an inference result obtained by inference in response to input data to the inference model or for encrypting the input data;
decrypting the encrypted inference model based on the first key included in the license; and
performing the inference based on the inference model.

14. An information processing device comprising:
a license generation unit that generates the license including a first key and a second key based on licensing rule information that indicates a rule for licensing an inference model and either an inference result obtained by inference in response to input data to the inference model or the input data, the first key being for decrypting the inference model encrypted, the second key being for encrypting the inference result or the input data; and
a communication unit that transmits the license to a device that uses the inference model.

15. The information processing device according to claim 14, wherein the license generation unit generates the license including encryption rule information indicating an encryption condition for the inference result or the input data.

16. The information processing device according to claim 15, wherein the encryption condition is a condition that the inference result or the input data is encrypted with a third key generated for each predetermined period or for each inference result or input data.

17. The information processing device according to claim 16, wherein the license generation unit further generates a license for the inference result or the input data based on the licensing rule information, the license including the third key.

18. The information processing device according to claim 14, further comprising a key derivation unit that generates the second key based on the first key and a public key for public key cryptography for the device.

19. The information processing device according to claim 18, wherein the license generation unit generates the license including the first key encrypted with the public key and the second key encrypted with the public key.

20. An information processing method performed by an information processing device, the information processing method comprising:
generating the license including a first key and a second key based on licensing rule information that indicates a rule for licensing the inference model and either an inference result obtained by inference in response to input data to the inference model or the input data, the first key being for decrypting the inference model encrypted, the second key being for encrypting the inference result or the input data; and
transmitting the license to a device that uses the inference model.
